(19) United States
(12) Patent Application Publication
(10) Pub. No.: US 2003/0108106 A1
(43) Pub. Date: Jun. 12, 2003

(54) Device for accelerating calculation of the centroids of markers in a system for motion analysis

(76) Inventors: Antonio Pedotti, Milan (IT); Giancarlo Ferrigno, Milan (IT)

Correspondence Address: Abelman Frayne & Schwab, 150 East 42nd Street, New York, NY, 10017-5612, US

(21) Appl. No.: 10/204,641

(22) PCT Filed: Feb. 19, 2001
(86) PCT No.: PCT/EP01/01834

(30) Foreign Application Priority Data
Feb. 21, 2000 (IT) MI2000A000304

(51) Int. Cl. H04N 7/12

(52) U.S. Cl. 375/240.26; 382/278; 382/288

(57) ABSTRACT

A device for accelerating calculation of the centroids of markers in a system for real time motion analysis is described, said system utilising images taken cyclically by a plurality of television cameras to follow the movements through time of a plurality of markers, each of which occupies a plurality of elementary units (pixels) of each television image frame: the centroid of these pixels indicates the instant position of the corresponding marker. The device according to the invention selects from the pixels of a set zone of a television image frame those occupied by the same marker and transfers these simultaneously to the circuit for calculation of the centroid.

### FIELD OF THE INVENTION

The invention consists of a device that permits acceleration of the calculation of the centroids in a system for real time motion analysis, of the type known in the literature with the name of “ELITE” (ELaboratore di Immagini TElevisive), which utilizes images taken cyclically by a plurality of television cameras to follow the movements through time of a plurality of markers, each of which occupies a plurality of elementary units (pixels) of each television image frame: the centroid of these pixels indicates the instant position of the corresponding marker.

The device according to the invention selects from the pixels of a set zone of a television image frame those occupied by the same marker and transfers these simultaneously to the circuit for calculation of the centroid of the markers.

### PRIOR ART

Systems for motion analysis that make use of two-dimensional cross-correlation (i.e. ELITE) can enhance their performance by exploiting the information contained in the so-called “shades of grey” of the correlation function: this permits a considerable increase (even ten or more times) in the resolution of the system, which becomes extremely accurate even if used with markers of small dimensions. The information contained in the shades of grey of the correlation functions is used to calculate a weighted centroid of all pixels belonging to the image of a marker with a correlation function value of no less than a set threshold value.

The coordinates of the weighted centroid are calculated using the following formulae:

$${x}_{c} = \frac{{\sum }_{i , j} {x}_{i , j} {R}_{i , j}}{{\sum }_{i , j} {R}_{i , j}} e {y}_{c} = \frac{{\sum }_{i , j} {y}_{i , j} {R}_{i , j}}{{\sum }_{i , j} {R}_{i , j}} \qquad ( 1 )$$

where x_{c} and y_{c} are the coordinates of the centroid of the marker and R_{i,j} is the value of the correlation function corresponding to the pixels (i,j) of coordinates x_{i,j}, y_{i,j}.

The block diagram of a known correlation system is indicated in FIG. 1.

In a single image frame various markers may be present simultaneously, perhaps even on the same row: this fact means that the calculation block of the centroid (CB; FIG. 1) receives several pixels (represented by packets x_{i,j}, y_{i,j}, R_{i,j}) belonging to several markers; by indicating the index of the marker with k, the packets will be given by terns of the type x_{i,j,k}, y_{i,j,k}, R_{i,j,k}, with k unknown.

The first operation to perform in order to calculate the centroids is the grouping of pixels belonging to the same marker, or definition of the values of k: this grouping can be performed by calculating the centre gravity of the markers for each row and checking, each time a new packet is encountered, whether this belongs to a marker currently being processed or belongs to a new marker.

A possible procedure, already known, to check whether a new packet belongs to a marker already being processed or a new marker is now described briefly with reference to the image frame in FIG. 2, which represents a possible distribution of pixels that have a correlation function value R_{i,j,k} of no less than the set threshold value and which correspond to the following packets: 1,3,10; 2,2,15; 2,3,80; 2,4,5; 2,7,6; 2,8,7; 3,3,12; 3,6,6; 3,7,58; 3,8,62; 4,7,12;

The first packet is examined and, as the memory of the markers already found must be empty at the start of the procedure, it is recognized as a new marker (k=1) in position (1,3) with correlation value equal to 10:the values (1,3,10) are placed in position 1 of the memory of the markers already found.

When the next packet (2, 2, 15) is found, all the markers already found (only number 1) are compared and it is seen that the distance of the new point from the content of the cell k=1 is lower than a set value (for example, the square root of 2); the new pixels belong to the marker 1 and the centroid can be updated as follows:

$${x}_{c} = \frac{3 \cdot 10 + 2 \cdot 15}{10 + 15} e {y}_{c} = \frac{1 \cdot 10 + 2 \cdot 15}{10 + 15}$$

A new value of i, j and R_{i,j} (2.4, 1.6, 25) is thus stored In the cell k=1.

The next two packets are still near the centroid calculated for marker 1 and are therefore utilized to update this centroid; instead, the packet (2,7,6) is at a distance greater than 3 from the marker 1 and, as no other markers have been memorized, this forms the marker 2 (k=2) which thus starts from a state (2,7,6). By iterating this procedure the final calculation is reached of the centroids of the two markers present on the image frame illustrated in FIG. 2.

It is evident that the operations required to calculate the position of the centroid according to the aforesaid procedure, although only composed of products, sums and divisions (this distance can also be calculated squared to save the root operation), involve a series of tests and exploration of vectors (memory of the markers already found) which requires a certain expenditure of calculation time.

As applications of systems for motion analysis at times require calculation and representation of the coordinates of the centroid in real time [with a delay of one frame at the most] and as processed data (centroids) occupy less space than the total of the packets required for processing, it is advantageous to perform calculation of the centroids of the markers present on one image frame in the time range between sampling of one frame and that of the next frame, i.e. in a sampling interval (T=1/Fc, where Fc is the sampling frequency).

As the sampling frequency may be high (over 200 Hz), the time available for calculation may be extremely short (5 milliseconds at 200 Hz) and may not be sufficient for a large number of markers (>20).

The device for calculating the centroids according to this invention permits maximum acceleration of calculation, selecting and grouping pixels which are occupied by the same marker from a set zone of a television image frame, processing the pixels parallel to one another to obtain data relevant to the position of the centroid and simultaneously transferring the data thus obtained to the circuit for calculation of the centroid.

### SUMMARY OF THE INVENTION

The subject of the present invention is a device to accelerate calculation of the centroids of markers in a system for motion analysis which comprises, in combination:

means to select a section of an image frame and to acquire the value of the correlation function of each pixel belonging to the aforesaid section; these means comprise a plurality of memory cells, organized in matrices, in each of which the value of the correlation function of a pixel belonging to the aforesaid section of the image frame is memorized;

first means activating their own output if the value of the correlation function of all the pixels memorized in the memory cells located along the edge of the matrix is lower than a set value;

second means activating their own output if the value of the correlation function of at least one of the pixels memorized in the memory cells located in the central zone of the matrix is not below the aforesaid set value;

means to implement the weighted sum of the values of the correlation function of the pixels memorized in the memory cells belonging to the columns, respectively to the rows of the central zone of the matrix;

output means with inputs regularly connected to the outputs of the first and second means and of the means of the weighted sum, to generate, in response to the data received by the aforesaid first and second means and from the means of the weighted sum and to the coordinates of a set memory cell belonging to the matrix, a message to be sent to means for calculation of the centroid before deleting the content of the memory cells.

### BRIEF DESCRIPTION OF THE FIGURES

The invention will now be described in more detail with reference to a not limiting embodiment illustrated in the annexed figures, in which:

FIG. 1 illustrates a block diagram of a correlation system of the known type;

FIG. 2 illustrates an unlimited example of an image frame;

FIG. 3 illustrates a simplified block diagram of a device according to the invention;

FIG. 4 schematically illustrates an embodiment of the block MC of FIG. 3;

FIG. 5 schematically illustrates an embodiment of the block C of FIG. 3;

FIG. 6 schematically illustrates an embodiment of the block D of FIG. 3;

FIG. 7 schematically illustrates an embodiment of the block N1 of FIG. 3;

FIG. 8 schematically illustrates an embodiment of the block N2 of FIG. 3;

FIG. 9 schematically illustrates an embodiment of the block OU of FIG. 3;

In the annexed figures, the corresponding elements will be identified with the same numeric references.

### DETAILED DESCRIPTION OF THE INVENTION

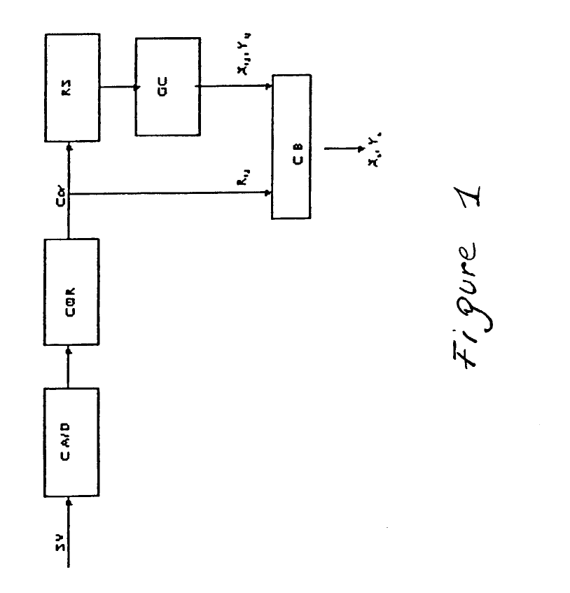

FIG. 1 shows a block diagram that identifies the various functions of a known correlation system, in which the analogue video signal SV, coming from the television cameras of the detection system (or from other equivalent means) is converted into a digital signal by the convertor C/A/D and reaches at the two-dimensional correlator COR which establishes the value R_{i,j} of the correlation function for each pixel belonging to an image frame.

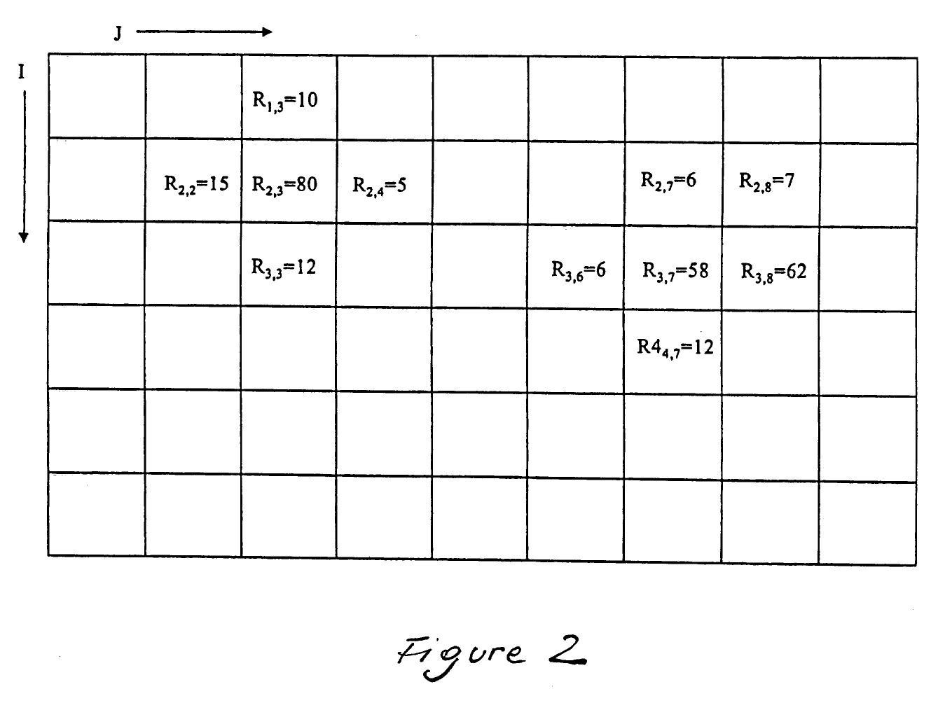

The coordinate generator GC establishes the coordinates (x, y) of each pixel for which the value R of the correlation function is not below the threshold value of the threshold circuit RS: these coordinates and the value R of the correlation function form the packets (R, x, y) that reach the circuit (known) to calculate the centroid CB, which processes them as described above with reference to FIGS. 1 and 2. The threshold circuit RS (already known) utilized in the correlation system allocates a null value to the correlation function R of a pixel if this value is below the threshold value of the threshold circuit RS.

FIG. 2 schematically illustrates the image frame that was used, merely as a not limiting example, to briefly describe a possible procedure, already known, to is assess whether a new packet belongs to a marker that is already being processed or to a new marker.

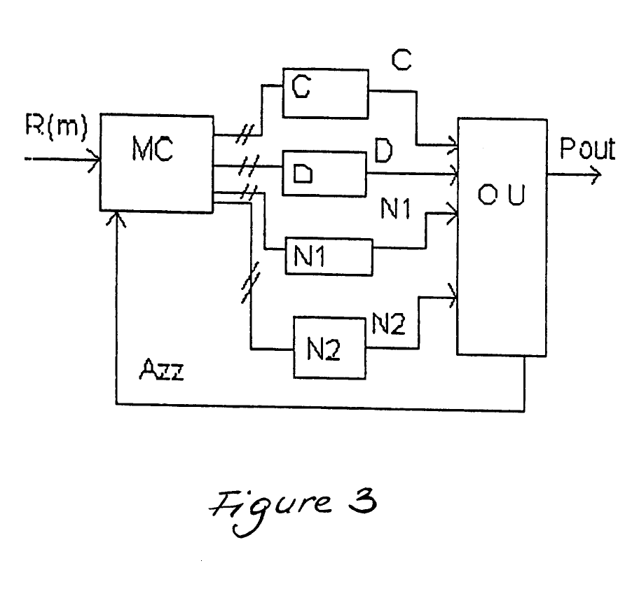

FIG. 3 illustrates a simplified block diagram of a device for accelerating the calculation of centroids in a system for motion analysis, implemented according to the invention, which comprises a combination of:

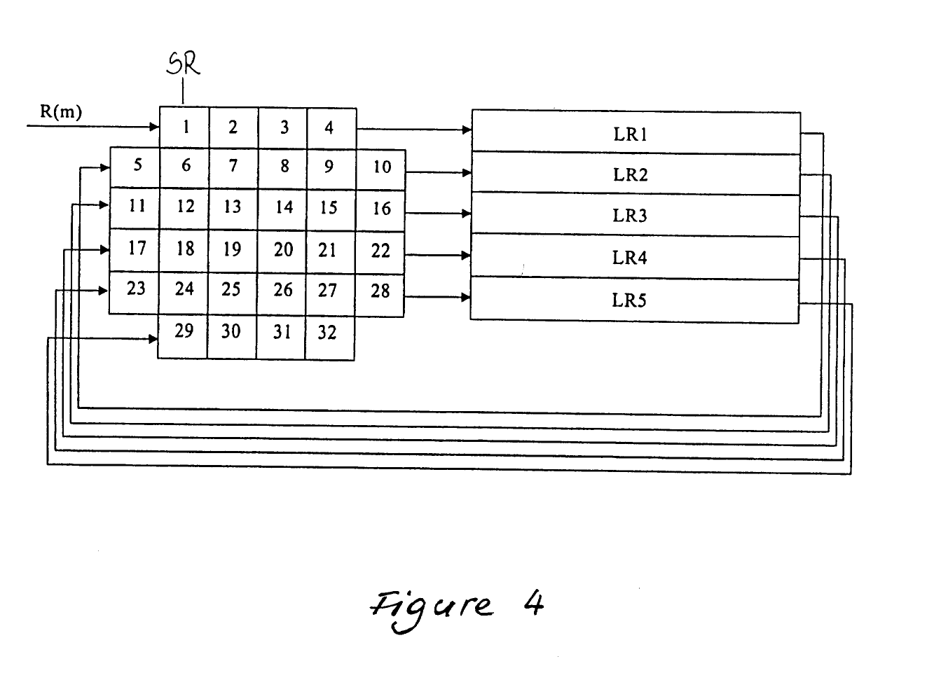

means MC (FIG. 4) which select a section of an image frame and acquire the value R_{i,j} of the correlation function of each pixel belonging to the aforesaid section; these means MC comprise a plurality of memory cells, organized in matrices, in each of which the value R_{i,j} of the correlation function of a pixel belonging to the aforesaid section of the image frame is memorised;

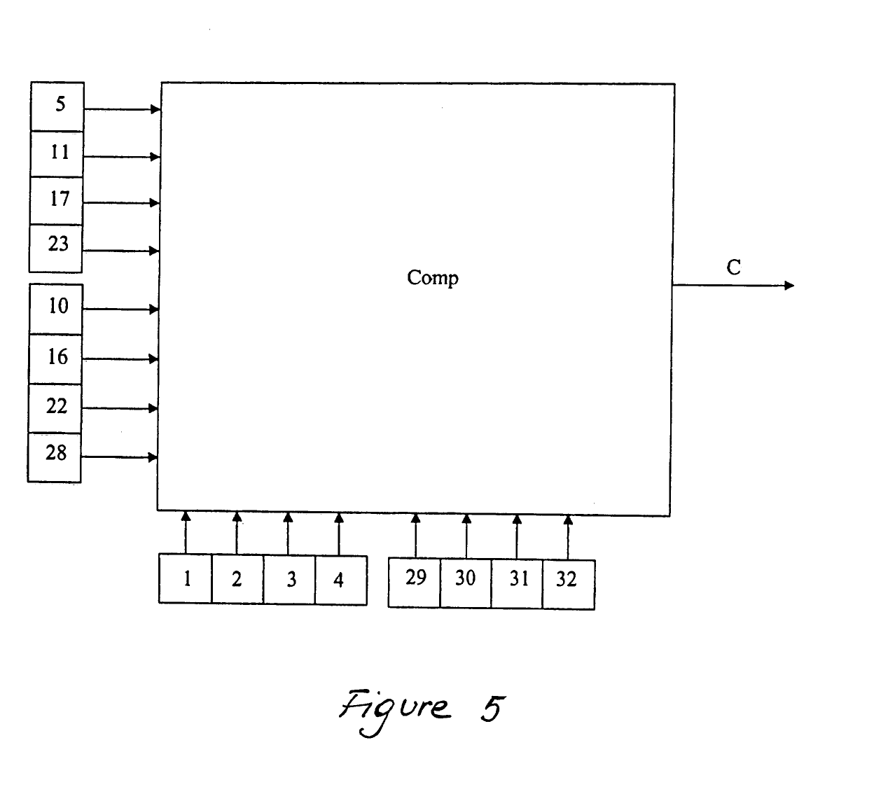

first means C (FIG. 5) which activate their output (making it differ from zero) if the value R_{i,j} of the correlation function of all the pixels memorized in the memory cells located along the edge of the matrix is below a set value;

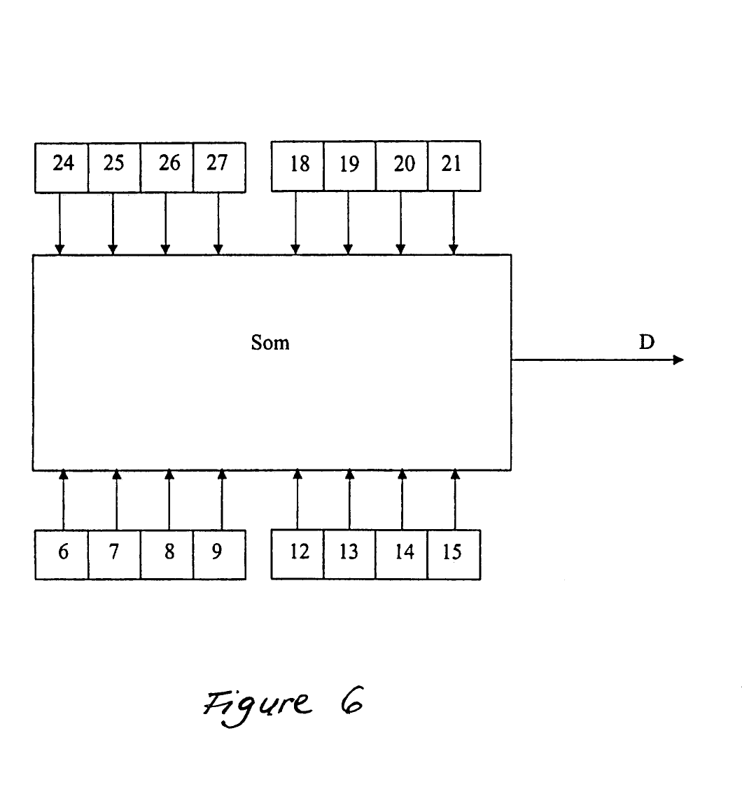

second means D (FIG. 6) which generate an output signal different from zero if the value R_{i,j} of the correlation function of at least one of the pixels memorized in the memory cells located in the central zone of the matrix is not below the aforesaid set value;

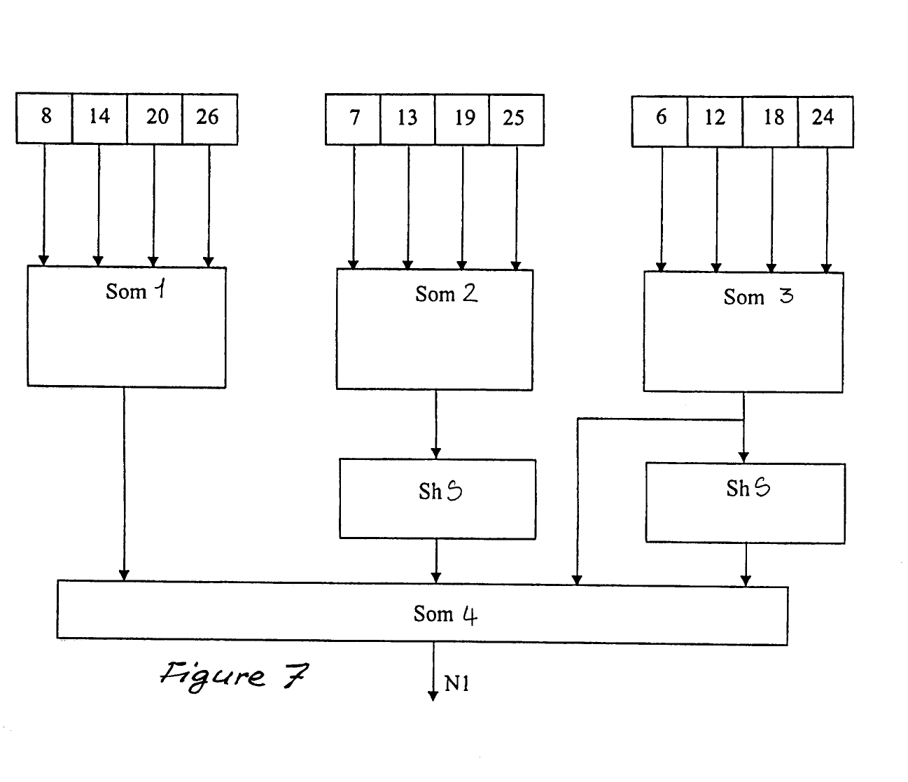

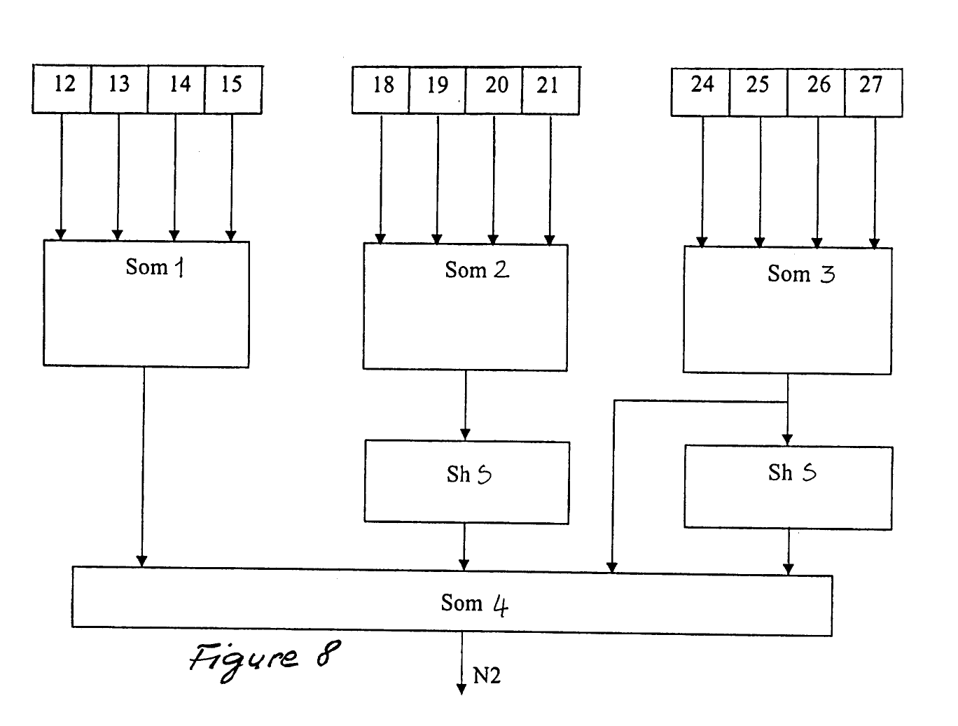

means (N1, N2; FIGS. 7, 8) which implement the weighted sum of the values R_{i,j} of the correlation function of the pixels memorized in the memory cells belonging to the columns, respectively to the rows of the central zone of the matrix;

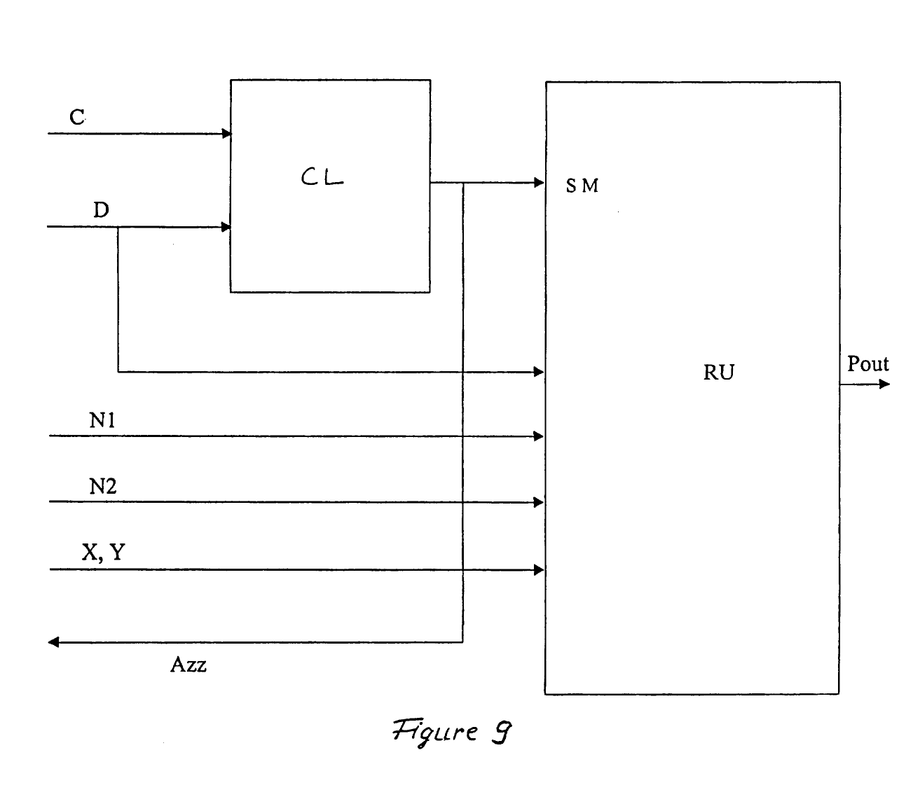

output means OU (FIG. 9), the inputs of which are connected to the outputs of the first and second means (C, D) and the weighted sum means (N1, N2) and which, in response to the data received by the aforesaid means (C, D, N1, N2) and to the coordinates (X, Y) of a set cell of the matrix, generate a message (Pout) to be sent to means (already known) for calculating the centroid before deleting the content of the memory cells.

FIG. 4 schematically illustrates an embodiment of selection means MC of FIG. 3, which comprise a shift register formed of a plurality of memory cells (32 in the embodiment of FIG. 4, where they are represented by means of 32 squares numbered in order from 1 to 32) organized in a matrix SR comprising k rows and k columns (where k is a set value; in the embodiment of FIG. 4 k=6) and (k−1) delay rows LR (5 delay rows in the embodiment of FIG. 4): the input of each is delay row LR is connected to the output of a row of the matrix SR and the output is connected to the input of the subsequent row of the matrix SR.

The value of k is established so that all the pixels of a marker (at least one of which must have a correlation value R_{i,j} that is not null) are certainly included in the square matrix (k−2)*(k−2) which forms the central zone of the matrix SR: simultaneously, the correlation values R_{i,j} memorized in the cells belonging to the edge of the matrix SR [which comprise two row-matrices and two column-matrices with the dimensions 1*(k−2) and (k−2)*1 respectively] must be null; on the contrary, the pixels associated to these non-null correlation values R_{i,j} would belong to the marker or to a second marker practically overlapping the first one, from which it cannot be distinguished.

The first and last row of the matrix SR comprise (k−2) memory cells, the intermediate rows of the matrix SR comprise k cells.

In the embodiment of FIG. 4 k=6: consequently, the central part of the matrix SR has a dimension of 4×4, the first and the last row of the matrix SR comprise 4 cells and the intermediate rows comprise 6 cells.

The operating principle of the device according to the invention is based on isolation inside the central zone of the matrix SR (comprising, in FIG. 4, the cells 6-9, 12-15, 18-21, 24-27) of all the pixels belonging to a marker: this results is considered attained when the value R_{i,j} of the correlation function memorized in at least one cell of the central zone of the matrix SR differs from zero and, simultaneously, the values R_{i,j} of the correlation function memorized in the edge of the matrix SR (comprising, in FIG. 4, the cells 1-5, 10, 11, 16, 17, 22, 23, 28-32) are null.

As known, an image frame is scanned row by row by a sensor whose signal comprises, in a series, the data relevant to the pixels of each row: if each row of the image frame (of which the means MC select a section) comprises N pixels, the distance between the positions occupied (in the “string” of data issued by the sensor) by the data relevant to two pixels that occupy the same position in two different rows of the image frame will be of N “clock” cycles if the rows are consecutive, of a multiple of N “clock” cycles if the rows are not consecutive.

At each “clock” cycle the value R_{i,j} of the correlation function of a pixel is memorized in the first cell of the matrix SR, while the values Ri,j already memorized in the block MC advance by one “step” in each row of the matrix SR and in the delay rows LR.

To isolate the correlation values R_{i,j} of the pixels belonging to the same marker in the central zone of the matrix SB the correlation values Ri,j out putting from each row of the matrix SR must be delayed by means of the delay rows LR before being introduced to the input of the subsequent row of the matrix SR, so that the values R_{i,j} of the correlation function of the pixels occupying the same position in two rows (even not consecutive) of the section of the image frame selected by the means MC occupy two vertically aligned cells of the matrix SR.

For this purpose, the first delay row (LR₁) and the intermediate delay rows (LR₂−LRₖ₋₂) [(LR₂−LR₄) in the embodiment of FIG. 4] comprise memory cells (N−k) [(N−6) cells in the embodiment of FIG. 4] while the last delay row (LRₖ₋₁) [LR₅ in the embodiment of FIG. 4] comprises (N−k+1) cells [(N−5) in the embodiment of FIG. 4].

FIG. 5 schematically illustrates an embodimentof the first means C of FIG. 3, which are composed of a comparator circuit (Comp), already known, to the inputs of which all the cells (in FIG. 4, the cells 1-5, 10, 11, 16, 17, 22, 23, 28-32) belonging to the edge of the matrix SR are connected.

The comparator circuit (Comp) activates its output C (making it different from zero) if the values R_{i,j} of the correlation function contained in the cells of the frame of the matrix SR are null.

FIG. 6 schematically illustrates embodiment of the second means D of FIG. 3, which are composed of an adder circuit (Som), already know, to the inputs of which all cells (in FIG. 4, the cells 6-9, 12-15, 18-21, 24-27) belonging to the central zone of the matrix SR are connected.

The adder circuit (Som) adds the values R_{i,j} of the correlation function contained in the cells connected to its inputs and generates an output signal D that will differ from zero if at least one of the values R_{i,j} of the correlation function contained in the cells of the central zone of the matrix SR is not null.

In response to activation of the outputs of the first and second means (C, D) the device according to the invention memorizes the values of the correlation function contained in the matrix SR and calculates the values N1 and N2 according to the formulae below:

$$N1 = {\sum }_{i , j} {x}_{i , j} {R}_{i , j} ; N2 = {\sum }_{i , j} {y}_{i , j} {R}_{i , j} \qquad ( 2 )$$

It is evident that, with reference to the formulae (1), N1/D and N2/D respectively represent the coordinates x_{c} and y_{c} of the weighted centroid.

Advantageously, the coordinates x_{i,j} and y_{i,j} of each cell of the central zone of the matrix SR refer to a system of Cartesian coordinates with the origin corresponding to a cell which occupies an angle of the central zone of the matrix SR (cell 9 in the embodiment described herein) and the axes (x, y) running from right to left, respectively from the top to the bottom: in this system of coordinates cell 6 has coordinates (3, 0); cell 7 has coordinates (2, 0); . . . ; cell 9 has coordinates (0, 0); cell 12 has coordinates t(3, 1); . . . ; cell 24 has coordinates (3,3); . . . ; cell 27 has coordinates (0,3).

Cells with null coordinates (x_{i,j} and y_{i,j}) can be omitted in the formulae (2); multiplication by one does not require any further circuit, multiplication by two of a binary number is obtained by “shifting” the number to the right by one bit and multiplication by three of a binary number is obtained by adding it to the same number “moved” to the right by one bit.

The circuits to calculate N1 and N2 are illustrated in FIGS. 7 and 8.

FIG. 7 schematically illustrates an embodiment of the block N1 of FIG. 3, which comprises three adder circuits (Som1-Som3) respectively connected to the inputs of which are the cells belonging to the same column of the central zone of the matrix SR and with coordinates xi,j that differ from zero (in FIG. 4 cells 8, 14, 20, 26; 7,13, 19, 25; 6, 12, 18, 24); two circuits (Sh S) with the input connected to the output of the second adder circuit Som2, with regard to the third adder circuit Som3 and used to “shift” the binary number applied to their input to the right by one bit and a further adder circuit (Som4) connected to the inputs of which are the outputs of adder circuits Som1 and Som3 and the outputs of the two circuits S Sh.

FIG. 8 schematically illustrates an embodiment of the block N2 of FIG. 3, analogous to the one illustrated in FIG. 7, from which it can be easily derived by replacing the columns with the rows of the matrix SR.

FIG. 9 schematically illustrates an embodiment of the block OU in FIG. 3, the inputs of which are connected to the outputs of the first and of the seconds means (C, D; FIGS. 5 and 6) and of the means of the weighted sum (N1, N2; FIGS. 7 and 8) and which generates, in response to the data received from the aforesaid means (C, D, N1, N2) and to the coordinates (X, Y)—referring to the system of reference of the image frame—of the cell of the matrix SR to which the origin of the coordinates of each cell of the central zone of the matrix SR corresponds, a message (Pout) to be sent to means for calculation of the centroid before deleting the content of the memory cells of the matrix SR to prevent the same marker from being recognized more than once.

The data contained in the output message Pout are transmitted simultaneously (with a single “clock” cycle”) to the means for calculation of the centroid.

The block OU comprises a logic circuit CL (which activates its output SM when the outputs of the first and of the second means C and D differ from zero simultaneously; FIGS. 5 and 6) and an output register RU, which acquires the data (X, Y, D, N1, N2) to be entered in the output message Pout and which sends them to the means for calculation of the centroid in response to activation of the output SM of the circuit CL.

The data N1, N2 and D permit calculation, by applying the formulae (2), of the position of the centroid of the pixels, relevant to the same marker, correlated to the values Ri,j of the correlation function memorized in the central zone of the matrix SR.

The output signal SM of the block CL also forms the signal Azz which deletes the content of the cells of the matrix SR.

Without departing from the scope of the invention, a technician may make all modifications and improvements suggested by normal experience and by natural evolution in the technique to the device concerned in the present description.

1. Device to accelerate calculation of the centroids of markers in a system for motion analysis, characterised in that it comprises, in a combination:
means (MC) to select a section of an image frame and to acquire the value (R_{i,j}) of the correlation function of each pixel belonging to the aforesaid section, said means (MC) comprising a plurality of memory cells organized in matrices in each of which is the value (R_{i,j}) of the correlation function of a pixel belonging to the aforesaid section of the image frame is memorised;
first means (C) activating their output (making it differ from zero) if the value (R_{i,j}) of the correlation function of all the pixels memorized in the memory cells located along the edge of the matrix is below a set value;
second means (D) generating an output signal that differs from zero if the value (R_{i,j}) of the correlation function of at least one of the pixels memorized in the memory cells located in the central zone of the matrix is not below the aforesaid set value;
means (N1, N2) to implement the weighted sum of the values (R_{i,j}) of the correlation function of the pixels memorized in the memory cells belonging to the columns, respectively to the rows of the central zone of the matrix;
output means (OU) with inputs connected to the outputs of the first and second means (C, D) and of the means of the weighted sum (N1, N2), to generate, in response to the data received by the aforesaid means (C, D, N1, N2) and to the coordinates (X, Y) of a set memory cell of the matrix, a message (Pout) to be sent to means for calculation of the centroid before deleting the content of the memory cells of the matrix.

2. Device as claimed in claim 1, characterized in that the selection means (MC) comprise (k−1) delay rows (LR) and a shift register organized in a matrix (SR) with k rows and k columns, each delay row (LR) having the input connected to the output of a row of the matrix (SR) and the output connected to the input of the subsequent row of the matrix (SR), k being a set value.

3. Device as claimed in claim 2, characterized in that the central zone of the matrix (SR) is formed of a square matrix (k−2)*(k−2) and in that the edge of the matrix (SR) comprises two row-matrices and two column-matrices with the dimensions 1*(k−2) and (k−2)*1] respectively.

4. Device as claimed in claim 3, characterized in that the first and last row of the matrix (SR) comprise (k−2) memory cells and that the intermediate rows of the matrix (SR) comprise k memory cells.

5. Device as claimed in claim 2, characterized in that the first delay row (LR₁) and the intermediate delay rows (LR₂−LRₖ₋₂)) comprise (N−k) memory cells and in that the last delay row (LRₖ₋₁) comprises (N−k+1) memory cells, N being the number of pixels in each row of the image frame.

6. Device as claimed in claim 1, characterized in that the first means (C), which activates its own output (C), making it differ from zero, if the value (R_{i,j}) of the correlation function of all the pixels memorized in the memory cells located along the edge of the said matrix is below a set value, comprise a comparator circuit (Comp) to the inputs of which all the memory cells located along the edge of the matrix are connected.

7. Device as claimed in claim 1, characterized in that the second means (D) which generates an output signal (D) differing from zero if the value (R_{i,j}) of the correlation function of at least one of the pixels memorized in the memory cells located in the central zone of the matrix is not below a set value comprises a adder circuit (Som), to the inputs of which all the memory cells located in the central zone of the matrix are connected.

8. Device as claimed in claim 1, characterized in that the coordinates (x_{i,j}, y_{i,j}) of the memory cells belonging to the central zone of the matrix refer to a system of cartesian coordinates whose origin corresponds to a set memory cell located in an angle of the central zone of the matrix.

9. Device as claimed in claim 8, characterized in that the means (N1, N2) to implement the weighted sum of the values (R_{i,j}) of the correlation function of the pixels memorized in the memory cells belonging to the columns, respectively to the rows of the central zone of the matrix comprise, in combination:
three adder circuits (Som1-Som3) regularly connected to the inputs of which are the cells belonging to the same column, respectively to the same row of the central zone of the matrix SR and whose coordinates (xi,j and yi,j) are different from zero;
two circuits (Sh, S) with the input connected to the output of the second adder circuit (Som2), respectively to the third adder circuit (Som3) and used to shift the binary number applied to their input to the right by one bit; and
a further adder circuit (Som4) connected to the inputs of which are the outputs of the first and third adder circuits (Som1, Som3) and the outputs of the two shifting circuits (Sh S).

10. Device as claimed in claim 8, characterized in that the inputs of the output means (OU) are connected to the outputs of the first and of second means (C, D) and of the means of the weighted sum (N1, N2) and generate, in response to the data received by the aforesaid means (C, D, N1, N2) and to the coordinates (X, Y) of the aforesaid set cell located in an angle of the central zone of the matrix, an output message (Pout) to be sent to means for calculation of the centroid before deleting the content of the memory cell.

11. Device as claimed in claim 10, characterized in that the data contained in the output message (Pout) are transmitted simultaneously to the means for calculation of the centroid.

12. Device as claimed in claim 10, characterized in that the output means (OU) comprise a logic circuit (CL) and an output register (RU), which acquires the data (X, Y, D, N1, N2) to be entered in the output message (Pout) and which sends them to the means for calculation of the centroid in response to activation of the output (SM) of the logic circuit (CL), said logic circuit (CL) activating its own output (SM) when the outputs of the first and of the second means (C, D) differ from zero simultaneously.

13. Device as claimed in claim 12, characterized in that the output signal (SM) of the logic block (CL) also deletes the content of the memory cells of the matrix.
